(19) United States
(12) Patent Application Publication
(10) Pub. No.: US 2022/0036842 A1
(43) Pub. Date: Feb. 3, 2022

(54) DISPLAY MODULE AND DISPLAY DEVICE

(71) Applicant: HKC CORPORATION LIMITED, Shenzhen (CN)

(72) Inventors: Zeyao LI, Shenzhen (CN); Chongwei Tang, Shenzhen (CN)

(73) Assignee: HKC CORPORATION LIMITED

(21) Appl. No.: 17/324,669

(22) Filed: May 19, 2021

(30) Foreign Application Priority Data
Jul. 28, 2020 (CN) 202010742332.2

(51) Int. Cl. G09G 3/36

(52) U.S. Cl. CPC G09G 3/3648; G09G 2320/0242; G09G 3/3688; G09G 3/3677

(57) ABSTRACT

The disclosure discloses a display module and a display device. The display module includes a display panel with a display area and an installation area. The installation area is located at the side of the display area. The display panel includes a plurality of pixel units, each pixel unit includes a main pixel area and a sub-pixel area. The pixel driver is arranged in the installation area and electrically connected with each pixel unit, and is to drive the main pixel and the sub-pixel in the pixel unit to work. Since the pixel unit is far away from the pixel driver, the area of the main pixel area of the pixel unit gradually increases and the area of the sub-pixel area gradually decreases.

### CROSS REFERENCE OF THE DISCLOSURE

The present disclosure present application claims the benefits of Chinese Patent No. 202010742332.2 and entitled “DISPLAY MODULE AND DISPLAY DEVICE”, which is filed on Jul. 28, 2020, and the entire disclosure of which is hereby incorporated by reference, in its entirety, for all that it teaches and for all purposes.

### TECHNICAL FIELD

The disclosure relates to the technical field of photoelectric display, in particular to a display module and a display device.

### BACKGROUND

In the large-size panel, due to the delay of scanning signal and data signal, the large visual angle effect at different positions will be inconsistent, which makes the color difference at different positions of the panel under the condition of large visual angle, affecting the display effect.

### SUMMARY

The main purpose of the disclosure is to provide a display module and a display device, aiming at solving the problem of large color difference between a positive visual angle and a large visual angle.

In order to achieve the above object, the present disclosure provides a display module, which includes:

a display panel with a display area and a installation area, wherein the installation area is located at a side of the display area; the display panel includes a plurality of pixel units, each pixel unit comprises a main pixel area and a sub-pixel area;

a pixel driver arranged in the installation area and electrically connected with each pixel unit, set to drive a main pixel and a sub-pixel in the pixel unit;

as distances of the pixel units from the pixel driver increase, sizes of main pixel areas of the pixel units increase and sizes of sub-pixel areas decrease.

Optionally, the pixel driver is a source driver, a first side and a second side are disposed opposite to each other in the display area, and the source driver is disposed in an installation area of the first side;

from the first side to the second side of the display area, as the distances of the pixel units from the pixel driver increase, the sizes of the main pixel areas of the pixel units increases and the sizes of the sub-pixel areas decrease.

Optionally, the pixel driver is a gate driver, the display area has a first side and a second side disposed opposite to each other, and the gate driver is disposed in an installation area of the first side of the display panel;

from the first side to the second side of the display area, as the distances of the pixel units from the pixel driver increase, the sizes of the main pixel areas of the pixel units increases and the sizes of the sub-pixel areas decrease.

Optionally, the pixel driver is a gate driver, the gate driver comprises a first gate driver and a second gate driver;

the number of the installation area is two, and two installation areas are arranged on a first side and a second side oppositely in the display area;

the first gate driver and the second gate driver are respectively arranged in the installation area of the first side and the installation area of the second side of the display panel, in a direction away from both the first gate driver and the second gate driver, as the distances of the pixel units from the first gate driver and the second gate driver increase, the sizes of the main pixel areas of the pixel units increases and the sizes of the sub-pixel areas decrease.

Optionally, a weight of the main pixel area occupying an area of the pixel unit is a, and a weight of the sub-pixel area occupying the area of the pixel unit is b, a value range of the weight a is 0<a<1, and the weight b=1−a.

Optionally, in the display panel, from top to bottom and/or from left to right, sizes of the main pixel areas gradually increase and sizes of the sub-pixel areas gradually decrease, with a sum of the main pixel area and the sub-pixel area of each pixel remaining unchanged.

Optionally, the display panel includes a frame glue disposed within a non-display region between an array substrate and a color film substrate, surrounding a liquid crystal layer.

Optionally, a maximum value of the weight a of the main pixel area is c, and the minimum value of the area weight b of the sub-pixel area is 1−c.

Optionally, the weight a of the main pixel area and the weight b of the sub-pixel area vary linearly.

Optionally, the display panel includes:

an array substrate;

a plurality of scanning lines arranged on the array substrate;

a plurality of data lines arranged on the array substrate;

a plurality of first and second switching elements; wherein each of the data lines is simultaneously connected with one of the first switching elements and one of the second switching elements, and each of the scanning lines is simultaneously connected with one of the first switching elements and one of the second switching elements; wherein,

in each of the pixel units, a scanning line connected to the main pixel area and a scanning line connected to the sub-pixel area are the same, and a data line connected to the main pixel area and a data line connected to the sub-pixel area are the same.

The present disclosure further provides a display module including:

a display panel with a first side and a second opposite to each other, the display panel including a plurality of pixel units, each pixel unit including a main pixel area and a sub-pixel area;

a source driver or a gate driver arranged on the first side of the display panel;

from the first side to the second side of the display area, as the distances of the pixel units from the source driver or the gate driver increase, the sizes of the main pixel areas of the pixel units increases and the sizes of the sub-pixel areas decrease;

a weight of the main pixel area occupying an area of the pixel unit is a, and a weight of the sub-pixel area occupying the area of the pixel unit is b, a value range of the weight a is 0<a<1, and the weight b=1−a;

a maximum value of the weight a of the main pixel area is c, and the minimum value of the area weight b of the sub-pixel area is 1−c.

The present disclosure further provides a display device including the display module above.

According to the disclosure, a main pixel area 131 and a sub-pixel area 132 for each pixel unit 130 of a plurality of pixel units 130 of the display panel 100. And from the side of the display area 110 close to the installation area 120 to the side away from the installation area 120, the area of the main pixel area 131 of the pixel unit 130 is larger and the area of the sub-pixel area 132 is smaller when the pixel unit 130 is closer to the side away from the installation area 120. According to the principle that the area of the main pixel area and the sub-pixel area determine a capacitance of the pixel electrodes, the capacitance of the main pixel area and the sub-pixel area is adjusted by adjusting the area size of the two, so that the charging conditions at different positions are consistent and the charging of the entire display panel is ensured to be uniform. In this way, the display effect can be greatly improved, so that when viewing a display device, such as a television, at a positive visual angle and a large visual angle, large color differences will not be generated, and consumers may appreciate pure colors and lifelike image quality at any angle, thus enabling consumers to have better visual enjoyment.

### BRIEF DESCRIPTION OF THE DRAWINGS

In order to have the embodiment of the present disclosure or the technical scheme in the related art more clearly explained, a brief description will be made of the accompany drawings used in the description of embodiments or related art. It will be apparent that the drawings in the following description are only some embodiments of the disclosure, and other drawings may be obtained from the structure shown in these drawings without creative effort by those of ordinary skill in the art.

FIG. 1 is a schematic structural diagram of an embodiment of a display module according to the present disclosure.

FIG. 2 is a schematic structural diagram of another embodiment of the display module of the present disclosure.

FIG. 3 is a schematic structural diagram of an embodiment of a pixel unit in the display module of the present disclosure.

FIG. 4 is a schematic structural diagram of another embodiment of the pixel unit in that display module of the present disclosure.

FIG. 5 is a schematic diagram of a circuit structure of an embodiment of the display module of the present disclosure.

FIG. 6 is a schematic diagram of a circuit structure of another embodiment of the display module of the present disclosure.

FIG. 7 is a schematic diagram showing a linear variation relationship between the area weights of main pixel area and sub-pixel area in the display module of the present disclosure;

FIG. 8 is a schematic diagram showing a nonlinear variation relationship between the area weights of the main pixel area and the sub-pixel area in the display module of the present disclosure.

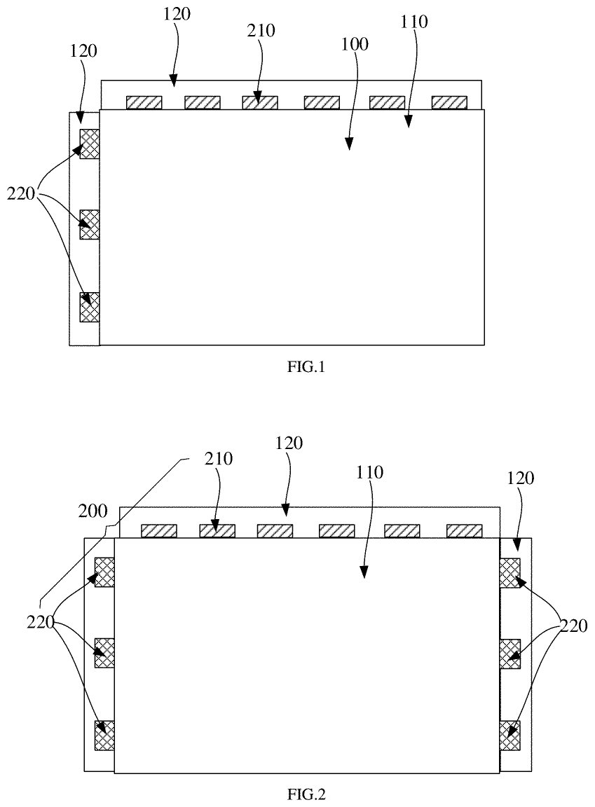

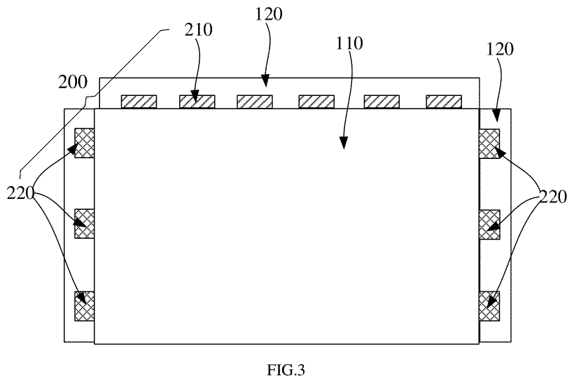

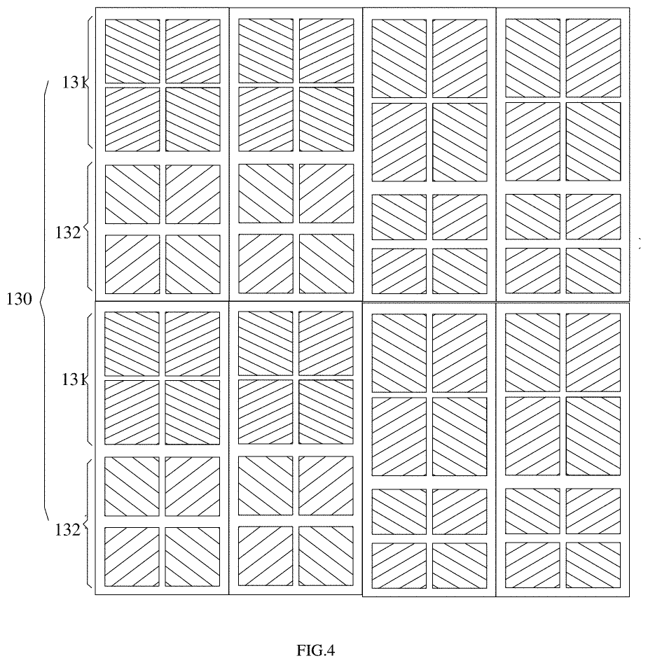

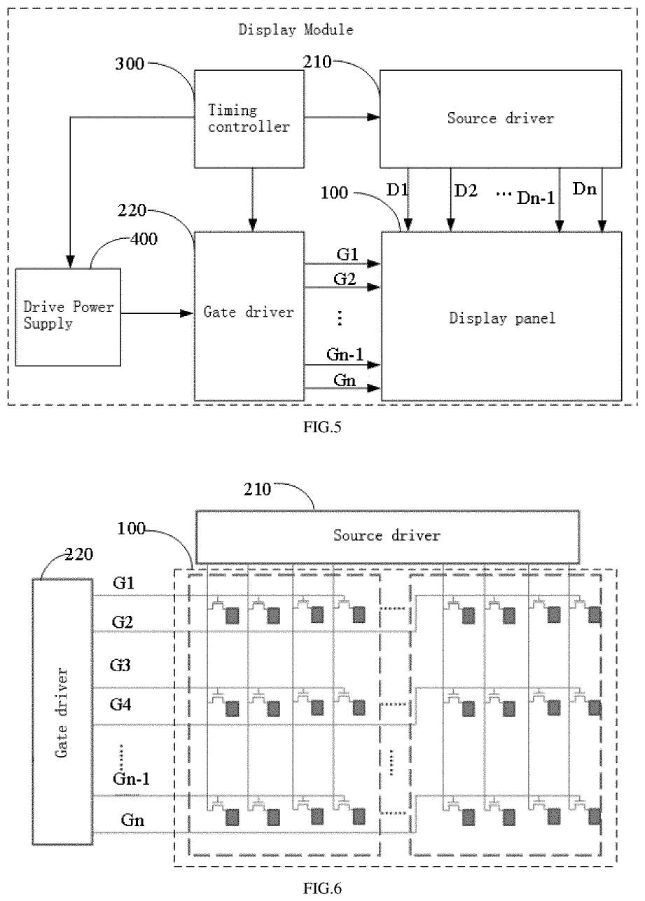

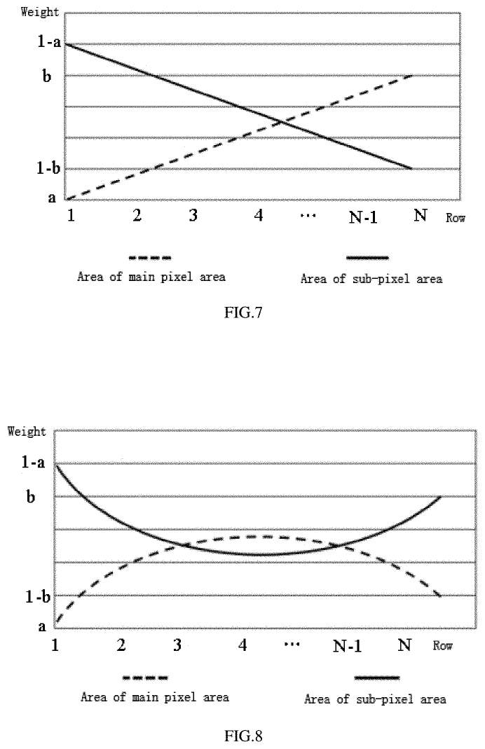

### DESCRIPTION OF THE DRAWINGS

| Label | | Label | |
|---|---|---|---|
| number | Name | number | Name |
| 100 | Display Panel | 200 | Pixel Drive |
| 110 | Display Area | 210 | Source driver |
| 120 | Installation area | 220 | Gate driver |
| 130 | Pixel Unit | 300 | Timing Controller |
| 140 | Array substrate | 400 | Drive Power Supply |
| 150 | Color film substrate | 131 | Main Pixel Area |
| 160 | Liquid Crystal Layer | 132 | Sub-pixel Area |

The realization, functional features and advantages of the present disclosure will be further explained in connection with embodiments and with reference to the accompanying drawings

### DETAILED DESCRIPTION OF THE EMBODIMENTS

A clear and complete description of the technical aspect of the embodiments of the present disclosure will be given below in connection with the accompany drawings of the embodiments of the present disclosure, and it will be apparent that the described embodiments are only part of the embodiments of the present disclosure, and not all of them. Based on the embodiments of the present disclosure, all other embodiments obtained by those of ordinary skill in the art without creative work fall within the scope of protection of the present disclosure.

It should be noted that if there are directional indications (such as upper, lower, left, right, front, rear, etc.) in embodiments of the present disclosure, the directional indications are only used to explain the relative positional relationship, motion situation, etc. between components under a specific posture (as shown in the drawings), and if the specific posture changes, the directional indications also change accordingly.

In addition, if there are descriptions according to “first”, “second” and the like in embodiments of the present disclosure, the descriptions of “first”, “second” and the like are for descriptive purposes only and cannot be construed as indicating or implying their relative importance or implying the number of indicated technical features. Thus, features defined as “first” and “second” may explicitly or implicitly include at least one of the features. In addition, the technical solutions between various embodiments can be combined with each other, but must be based on the ability of one of ordinary skill in the art to realize, and when the combination of technical solutions is inconsistent or cannot be realized, it should be considered that the combination of such technical solutions does not exist and is not within the scope of protection claimed by the present disclosure.

The disclosure provides a display module, which is applied to display devices with display screens such as liquid crystal televisions and computers.

With the development of display screens of LCD TV and computers towards super-large size and high resolution, more and more LCD panels adopt narrow frame design to increase the display area of the display screens.

Accordingly, a gate driver for driving a liquid crystal display panel with a narrow frame design is generally arranged at the side frame position of the display panel, namely, each scanning line used for connecting the gate driver and thin film transistors cannot be traces with equal resistance, That is, the thin film transistor array near the gate driver, the scanning lines between the two are shorter, while the scanning lines between the thin film transistor array far away from the gate driver (i.e., far away from the side frame position) and the gate driver are longer. According to the calculation formula of resistance R=L/S, for traces with equal cross-sectional areas, the longer the length of the traces, the greater the resistance, and the shorter the length of the traces, the smaller the resistance (where R represents the trace resistance value, S represents the cross-sectional area of the traces, L represents the trace length, and p represents the resistivity of the traces). However, thin film transistors located in a same row are equivalent to being arranged in parallel on a same scanning line, so the charging voltage of pixels near the gate driver will be greater than the charging voltage of pixels far away from the gate driver. It can be understood that the higher the saturation of the charging voltage of the pixels, the brighter the brightness of the display panel, and vice versa. The liquid crystal display panel is mainly composed of a thin film transistor array substrate, a color film array substrate, and a liquid crystal sandwiched between the two substrates. Due to the area ratio of the main pixel area and the sub-pixel area, different brightness characteristics will be generated under the same charging voltage, which can reduce the problem of color deviation of large visual angle. However, due to the fact that in large size panels, the scan signal and the data signal are delayed, the brightness of the display area close to the gate driver is greater than that of the display area far away from the gate driver, so that the brightness of the area far away from the gate driver and the area close to the gate driver of the panel are uneven due to uneven charging. As a result, the large visual angle effect in different positions will be inconsistent, which makes the color difference in different positions of the panel under the condition of large visual angle, affecting the display effect.

In order to solve the above problems, according to FIG. 1, in an embodiment of the present disclosure, the display module includes:

a display panel 100 with a display area 110 and an installation area 120, the installation area 120 being positioned on a side of the display area 110. The display panel 100 includes a plurality of pixel units 130, each pixel unit 130 includes a main pixel area 131 and a sub-pixel area 132;

a pixel driver 200 disposed in the installation area 120 and electrically connected to each pixel unit 130, set to drive a sub-pixel and a sub-pixel in the pixel unit 130;

with a distance of a pixel unit 130 from the pixel driver 200 increases, the area of the main pixel area 131 of the pixel unit 130 gradually increases and the area of the sub-pixel area 132 gradually decreases. That is, for every two pixel units 130 with different distances to the pixel driver 200, the area of the main pixel area 131 of the one that is far away from the pixel driver 200 is larger than the area of the main pixel area 131 of the other one, and the area of the sub-pixel area 132 of the one that is far away from the pixel driver 200 is less than the area of the sub-pixel area 131 of the other one.

In this embodiment, the pixel driver 200 is a source driver 210 and/or a gate driver 220, the display module also includes a timing controller 300 and a drive power supply 400. The timing controller 300 is connected to the gate driver 220, the source driver 210 and the drive power supply 400. The timing controller 300 is to receive data signals, control signals, and clock signals output by an external circuit module, and convert the data signals, the control signals, and the clock signals to be suitable for the gate driver 220 and the source driver 210, so as to realize the image display of the liquid crystal panel. The signal formats input by the timing controller 300 are generally transistor-transistor logic signals (TTL), low voltage differential signals (LVDS), embedded display signals (eDP), or V-by-One signals. The control signals output by the timing controller 300 includes a gate control signal and a source control signal, and the source drive signal includes a row start signal (STH), a row clock pulse signal (CPH), a data output signal (TP), and a data polarity reversal signal (MPOL or POL). The gate drive signal includes a Start Vertical signal (STV), a Clock Pulse Vertical signal (CPV), and an Output Enable signal (OE).

The drive power supply 400 integrates a plurality of DC-DC conversion circuits with different circuit functions, each of which outputs different voltage values. The input voltage of the drive power supply 400 is generally 5V or 12V, and the output voltage includes an operating voltage DVDD provided to the timing controller 300, and a gate on voltage Vgh and an off voltage provided to the gate driver 220.

The display panel 100 may be an OLED (Organic Light-Emitting Diode), or a TFT-LCD (Thin Film Transistor Liquid Crystal Display). The display panel 100 is composed of a plurality of pixels, and the plurality of pixels are arranged in a matrix. Each pixel consists of three sub-pixels of red, green and blue. Each sub-pixel consists of a thin film transistor and a capacitor. A plurality of odd-numbered rows of thin film transistors and capacitors and a plurality of even-numbered rows of thin film transistors and capacitors constitute the display panel 100. Among them, the plurality of thin film transistors form a switch array.

It should be noted that, the Thin Film Transistor (TFT)-Liquid Crystal Display (LCD) relies on the different orientations of liquid crystals in different electric fields. At this time, due to the optical birefringence of liquid crystals, different transmittances are produced when the light transmitted from a back light source to liquid crystals, thus generating gray scales. The color resistance of red, green and blue (RGB) primary colors can be placed on the optical path to obtain different colors and different bright and dark images. When viewing the liquid crystal display from a large visual angle, due to different angles, the penetration rate in each direction is also different, and the deviation values felt are also different, thus generating what the industry calls a Color shift phenomenon. In order to overcome this inherent defect of liquid crystal display, a large number of methods have been formed. At present, multi-domain method is widely used to make the state of liquid crystal seen by observers in all directions be in a state with the same average value, the eight-domain structure is used mostly.

Specifically, the main pixel area 131 includes four first sub-areas. Wherein, each of the first sub-areas 111 is arranged with corresponding pixel electrodes, and the pixel electrodes of the four first sub-areas form a fish spur shaped structure, so that the main pixel area 131 can realize four different liquid crystal orientations, so that the four first sub-areas 111 form four display domains.

In some embodiments, the sub-pixel area 132 includes four second sub-areas 121. Corresponding pixel electrodes are arranged on each second sub-area 121, and the pixel electrodes of the four second sub-areas 121 form a “ [symbol] ” shaped structure or a fish spur shaped structure, etc. The present application is not limited to these two structures, and here are only examples. Therefore, the sub-pixel area 132 can realize four different liquid crystal orientations, so that the four second sub-areas 121 form four display domains, and the entire pixel unit 130 forms eight display domains.

The installation area 120 may be a side on which the source driver 210 is provided or a side on which the gate driver 220 is provided, and the gate driver 220 and the source driver 210 are fixedly mounted to the sides of the display area 110 by a tape-loaded automatic binding process during the fabrication of the display module.

In the pixel array, the sub-pixels of a row is generally connected to the gate driver 220 through a scanning line, and the sub-pixels of a column is connected to the source driver 210 through a data line. When the gate driver 220 receives the timing control signal output by the timing controller 300, the gate driver 220 controls the thin film transistors to turn on row by row so that the source driver 210 outputs the data signal to the corresponding pixels, and then displays the image to be displayed. However, when the thin film transistors on a same row are distributed on the display panel 100, due to the uneven trace resistances of the scanning line between the area of the panel away from the gate driver 220 and the area close to the gate driver 220. Or, the data signal and the scanning signal will be delayed due to the uneven data line trace resistances between the area far away from the source driver 210 and the area close to the source driver 210, the large visual angle effect at different positions will be inconsistent, thus causing color difference at different positions of the panel under the large visual angle condition, and affecting the display effect.

To this end, the present disclosure provides a main pixel area 131 and a sub-pixel area 132 for each pixel unit 130 of a plurality of pixel units 130 of the display panel 100. And from the side of the display area 110 close to the installation area 120 to the side away from the installation area 120, the area of the main pixel area 131 of the pixel unit 130 is larger and the area of the sub-pixel area 132 is smaller when the pixel unit 130 is closer to the side away from the installation area 120. According to the principle that the area of the main pixel area 131 and the sub-pixel area 132 determine a capacitance of the pixel electrodes, the capacitance of the main pixel area 131 and the sub-pixel area 132 is adjusted by adjusting the area size of the two, so that the charging conditions at different positions are consistent and the charging of the entire display panel 100 is ensured to be uniform.

It should be noted that the change in the area of the main pixel area 131 and the area of the sub-pixel area 132 of the adjacent pixel units 130 may be specifically determined depending on the number of pixel units 130 in the display area 110, and is not limited in the embodiment of the present disclosure. In particular, embodiments of the present disclosure changes the proportions of the sub-pixel area 131 and the sub-pixel area 131 at the edge of the display area 110 to the area of the pixel unit 130. In the display area 110, the sub-pixel area 132 of the pixel unit 130 close to the source driver 210 or close to the gate driver 220 occupies a relatively large area, and the main pixel area 131 occupies a relatively small area, while the sub-pixel area of the pixel unit 130 far away from the source driver 210 or close to the gate driver 220 occupies a relatively small area, and the main pixel area 131 occupies a relatively large area. In this way, the display effect can be greatly improved, so that when viewing a display device, such as a television, at a positive visual angle and a large visual angle, large color differences will not be generated, and consumers may appreciate pure colors and lifelike image quality at any angle, thus enabling consumers to have better visual enjoyment.

In one embodiment, the display module further includes a source driver 210, the pixel driver 200 being the source driver 210, the display area 110 with a first side and a second side disposed opposite to each other, the source driver 210 being disposed in a installation area 120 of the first side.

From the first side to the second side of the display area 110, the areas of the main pixel areas 131 of the pixel units gradually increase, while the areas of the sub-pixel areas 132 gradually decrease.

In the pixel array, sub-pixels located in a same column may have different trace resistance and parasitic capacitance on the trace due to different distances between the traces of the data line in the display panel 100 and the source driver 210, so that the pixels on the same data line in the display panel 100 may be unevenly charged due to consumption and charging delay of the trace resistance and trace capacitance. When the source driver 210 is disposed on the first side, the proportions of the main pixel areas of the pixel units 130 increase with the increase of the distances between the main pixel areas and the source driver 210, and the proportions of the sub-pixel areas of the pixel units 130 decreases with the increase of the distances between the sub-pixel areas and the source driver 210. The capacitance of the main pixel area 131 and the sub-pixel area 132 are adjusted by adjusting the area sizes of the two, so that the charging conditions of the sub-pixels located on the same data line are consistent, thus realizing uniform charging of the entire display panel 100, and preventing large color difference between the positive visual angle and the large visual angle when being viewed.

In one embodiment, the display module further includes a gate driver 220, and the pixel driver 200 being the gate driver 220. The display area 110 with a first side and a second side disposed opposite to each other, the gate driver 220 is disposed in a installation area 120 of the first side of the display panel 100.

The pixel units are arranged from the first side to the second side of the display area 110, and the sizes of the main pixel areas 131 of the pixel units gradually increase, while the sizes of the sub-pixel areas 132 gradually decrease.

In the pixel array, the sub-pixels located in a same row may have different trace resistances and the parasitic capacitances due to different distances from the traces of the scanning line to the gate driver 220 in the display panel 100, so that the pixels on the same scanning line of the display panel 100 will have different sizes of turn-on signals due to the consumption of the trace resistances and the trace capacitances and a charging delay, resulting in uneven charging of each pixel. When the gate driver 220 is disposed on the first side, the proportion of the main pixel areas of the pixel units 130 increase with the increase of the distances between the main pixel areas and the gate driver 220, and the proportion of the sub-pixel areas of the pixel units 130 decrease with the increase of the distances between the sub-pixel areas and the gate driver 220. The capacitance of the main pixel area 131 and the sub-pixel area 132 are adjusted by adjusting the area sizes of the two, so that the charging conditions of the sub-pixels located on the same data line are consistent, thus realizing uniform charging of the entire display panel 100, and preventing large color difference between the positive visual angle and the large visual angle when being viewed.

In one embodiment, the pixel driver 200 is a gate driver 220 that includes a first gate driver 220 and a second gate driver 220.

There are two installation areas 120, and the two installation areas 120 are respectively arranged on a first side and a second side opposite to each other of the display area 110.

The first gate driver 220 and the second gate driver 220 are disposed in the installation area 120 on the first side and the installation area 120 on the second side of the display panel 100 respectively. In a direction away from the first gate driver 220 and the second gate driver 220, and the areas of the sub-pixel areas 131 of the pixel units 130 gradually increase and the areas of the sub-pixel areas 132 gradually decrease.

In this embodiment, the number of gate drivers 220 may be one or a plurality, and may be specifically set according to the size, resolution, etc. of the display panel 100, and is not limited here. Gate drivers 220 may be sequentially disposed on one side of the display panel 100, the gate drivers 220 may also be provided on two opposite sides of the display panel 100, which can be specifically set according to the size of the display panel 100. In this embodiment, in a super-large-sized display panel 100, the gate drivers 220 can be selectively set on two opposite sides of the display panel 100. The first gate driver 220 on one side and the second gate driver 220 on the other side are set one by one correspondingly, and the sub-pixels of the same row are simultaneously driven by the first gate driver 220 and the second gate driver 220 to open.

In this embodiment, the proportions of the main pixel areas of the pixel units 130 increase from the first side or the second side to a center line of the display panel 100, and the proportions of the sub-pixel areas of the pixel units 130 decrease from the first side or the second side to the center line of the display panel 100.

In one embodiment, an area weight of the area of the main pixel area 131 occupying the area of the pixel unit 130 is a, and an area weight of the area of the sub-pixel area 132 occupies the area of the pixel unit 130 is b, a value range of the area weight a is 0<a<1, and the weight b=1−a.

In the display panel 100, from top to bottom and/or from left to right, the sizes of the main pixel areas 131 gradually increase and the sizes of the sub-pixel areas 132 gradually decrease, with the sum of the main pixel area and the sub-pixel area of each pixel remaining unchanged. Specifically, in the first line of pixels, the area weight of the main pixel area 131 to the whole pixel is a (0<a<1), and the area weight of the sub-pixel area 132 to the whole pixel is 1−a. With the gradual increase of the number of rows, the area weights of the main pixel areas 131 to the whole pixel gradually increase, and the area weights of the sub-pixel areas to the whole pixel gradually decrease. At the last row, the area weight of the main pixel area reaches the maximum value c, and the area weight of the sub-pixel area reaches the minimum value 1−c. In another embodiment, the magnitude relationship of the weights a and 1−a is not limited.

In one embodiment, the area weight a of the pixel unit 130 and the weight b of the area of the sub-pixel area 132 are under linear variation. Alternatively, the weight a of the area of the pixel unit 130 and the weight b of the area of the sub-pixel area 132 are under non-linear variation.

In this embodiment, the weights of the main pixel area and the sub-pixel area may be changed linearly, which may also be changed nonlinearly, and may be set according to parameters such as the size of the display panel 100 and the type of the display panel 100. According to the principle that the areas of the main pixel area 131 and the sub-pixel area 132 will determine the capacitance of the pixel electrodes, the capacitance of the main pixel area 131 and the sub-pixel area 132 is adjusted by adjusting the weights of the two areas occupying the pixel unit 130, so that the charging conditions at different positions are consistent and the charging of the whole display panel 100 is ensured to be uniform.

In one embodiment, the display panel 100 includes:

a pixel array 150;

an array substrate 140;

a color film substrate 220 disposed opposite the array substrate 140;

a liquid crystal layer 160 disposed between the array substrate 140 and the color film substrate 220, the liquid crystal layer 160 including a plurality of liquid crystal molecules, and the pixel array 150 used for controlling operations of the plurality of liquid crystal molecules;

a plurality of scanning lines (G1, G2, G3 . . . GN) arranged on the array substrate 140;

a plurality of data lines (D1, D2, D3 . . . DN) disposed on the array substrate 140;

a plurality of first and second switching elements; each of the data lines is simultaneously connected with one of the first switching elements and one of the second switching elements, and each of the scanning lines is simultaneously connected with one of the first switching elements and one of the second switching elements.

In each of the pixel units 130, the scanning line connected to the main pixel area 131 and the scanning line connected to the sub-pixel area are the same, and the data line connected to the main pixel area 131 and the data line connected to the sub-pixel area are the same.

In this embodiment, both the array substrate 140 and the color film substrate 220 are generally transparent material substrates such as glass substrates or plastic substrates. The color film substrate 220 is disposed opposite to the array substrate 140, and a corresponding circuit may be provided between the array substrate 140 and the color film substrate 220.

In one embodiment, the display module further includes a gate driver 220 and a plurality of scanning lines, and a plurality of output terminals of the gate driver 220 are connected to gates of sub-pixels of each row in the pixel array one-by-one correspondingly through the scanning lines.

In the above embodiments, the pixel array 150 includes a plurality of sub-pixels. Each of the sub-pixels includes an active switch (thin film transistor) and a pixel electrode. A gate of the active switch T is electrically connected to a scanning line corresponding to the sub-pixel, a source of the active switch is electrically connected to a data line corresponding to the pixel unit 130, and a drain of the active switch is electrically connected to the pixel electrode of the sub-pixel. The pixel array also includes a pixel electrode array connected to an active switching element array.

The display panel 100 is composed of a plurality of pixels, and each pixel is composed of three sub-pixels of red, green and blue. Each sub-pixel circuit structure is generally provided with a thin film transistor and a capacitor. A gate of the thin film transistor is connected to the gate driver 220 through a scanning line, a source of the thin film transistor is connected to the source driver 210 through a data line, and a drain of the thin film transistor is connected to one terminal of the capacitor. A plurality of thin film transistors form a thin film transistor array (not shown in the figure). Thin film transistors located in a same column are connected to the source driver 210 through a data line, and thin film transistors located in a same row are connected to the gate driver 220 through a scanning line, thus forming the thin film transistor array. These thin film transistors may be a-Si (non-silicon) thin film transistors or Poly-Si (polysilicon) thin film transistors, the Poly-Si thin film transistors may be formed by using technologies such as LTPS (Low Temperature Poly-Silicon) and the like.

It will be appreciated that, in the above embodiment, the display panel 100 further includes a frame glue 170 disposed within a non-display region BB between the array substrate 140 and the color film substrate 220, surrounding the liquid crystal layer 160. The GOA circuit 100 is positioned between the frame glue 170 and the display region AA. A frame glue 170 may be applied to the array substrate 140 or the color film substrate 220 using sealant to connect the array substrate 140 and the color film substrate 220, thereby realizing the assembly process of the display panel 100. Specifically, the pixel array 150 is a half source driving (HSD) architecture pixel array 150.

The disclosure also provides a display module including:

a display panel 100 having opposing first and second sides, the display panel 100 including a plurality of pixel units 130, each pixel unit 130 including a sub-pixel area 131 and a sub-pixel area 132;

a source driver 210 disposed on the first side of the display panel 100.

In a direction of the pixel unit 130 away from the source driver 210 and the second gate driver 220, areas of main pixel areas 131 of the pixel units 130 gradually increase and areas of sub-pixel areas 132 gradually decrease.

A weight of an area of a main pixel area 131 occupying an area of the pixel unit 130 is a, and a weight of an area of a sub-pixel area 132 occupying the area of the pixel unit 130 is b, a value range of the weight a is 0<a<1, and the weight b=1−a.

The maximum value of the weight a of the sub-pixel area 131 is c, and the minimum value of the weight b of the sub-pixel area 132 is 1−c.

In the display panel 100, from top to bottom and/or from left to right, the sizes of the main pixel areas 131 gradually increases and the sizes of the sub-pixel area 132 gradually decrease, with a sum of the main pixel area and the sub-pixel area of each pixel remaining unchanged. Specifically, in the first line of pixels, the area weight of the main pixel area 131 to the whole pixel is a (0<a<1), and the area weight of the sub-pixel area 132 to the whole pixel is 1−a. With the gradual increase of the number of rows, the area weight of the main pixel areas 131 to the whole pixel gradually increase, and the area weight of the sub-pixel areas to the whole pixel gradually decrease. At the last row, the weight of the main pixel area reaches a maximum value c and the weight of the sub-pixel reaches a minimum value 1−c. In another embodiment, the magnitude relationship of the weight a and weight 1−a is not limited.

The disclosure also provides a display device, which includes the display module as described above. The detailed structure of the display module may refer to the above embodiments and will not be described here. It will be understood that since the above display module is used in the display device of the present disclosure, the embodiments of the display device of the present disclosure includes all the technical solutions of all the embodiments of the above-mentioned display module, and the technical effects achieved are exactly the same, and will not be repeated here.

The foregoings are only optional embodiments of the disclosure and are not thus limiting the scope of the patent of the disclosure. Any equivalent structural transformation made under the inventive concept of the disclosure using the contents of the specification and the accompanying drawings, or any direct/indirect application in other related technical fields, is included in the scope of the patent protection of the disclosure.

1. A display module comprising:
a display panel with a display area and a installation area, wherein the installation area is located at a side of the display area; the display panel comprises a plurality of pixel units, each pixel unit comprises a main pixel area and a sub-pixel area;
a pixel driver arranged in the installation area and electrically connected with each pixel unit, set to drive a main pixel and a sub-pixel in the pixel unit;
wherein as distances of the pixel units from the pixel driver increase, sizes of main pixel areas of the pixel units increase and sizes of sub-pixel areas decrease.

2. The display module according to claim 1, wherein the pixel driver is a source driver, a first side and a second side are disposed opposite to each other in the display area, and the source driver is disposed in an installation area of the first side;
from the first side to the second side of the display area, as the distances of the pixel units from the pixel driver increase, the sizes of the main pixel areas of the pixel units increases and the sizes of the sub-pixel areas decrease.

3. The display module according to claim 1, wherein the pixel driver is a gate driver, the display area has a first side and a second side disposed opposite to each other, and the gate driver is disposed in an installation area of the first side of the display panel;
from the first side to the second side of the display area, as the distances of the pixel units from the pixel driver increase, the sizes of the main pixel areas of the pixel units increases and the sizes of the sub-pixel areas decrease.

4. The display module according to claim 1, wherein the pixel driver is a gate driver, the gate driver comprises a first gate driver and a second gate driver;
the number of the installation area is two, and two installation areas are arranged on a first side and a second side oppositely in the display area;
the first gate driver and the second gate driver are respectively arranged in the installation area of the first side and the installation area of the second side of the display panel, in a direction away from both the first gate driver and the second gate driver, as the distances of the pixel units from the first gate driver and the second gate driver increase, the sizes of the main pixel areas of the pixel units increases and the sizes of the sub-pixel areas decrease.

5. The display module according to claim 1, wherein a weight of the main pixel area occupying an area of the pixel unit is a, and a weight of the sub-pixel area occupying the area of the pixel unit is b, a value range of the weight a is 0<a<1, and the weight b=1−a.

6. The display module according to claim 1, wherein, in the display panel, from top to bottom and/or from left to right, sizes of the main pixel areas gradually increase and sizes of the sub-pixel areas gradually decrease, with a sum of the main pixel area and the sub-pixel area of each pixel remaining unchanged.

7. The display module according to claim 1, wherein the display panel comprises a frame glue disposed within a non-display region between an array substrate and a color film substrate, surrounding a liquid crystal layer.

8. The display module according to claim 5, wherein a maximum value of the weight a of the main pixel area is c, and the minimum value of the area weight b of the sub-pixel area is 1−c.

9. The display module of claim 5, wherein the weight a of the main pixel area and the weight b of the sub-pixel area vary linearly.

10. That display module of claim 1, wherein the display panel comprises:
an array substrate;
a plurality of scanning lines arranged on the array substrate;
a plurality of data lines arranged on the array substrate;
a plurality of first and second switching elements; wherein each of the data lines is simultaneously connected with one of the first switching elements and one of the second switching elements, and each of the scanning lines is simultaneously connected with one of the first switching elements and one of the second switching elements; wherein,
in each of the pixel units, a scanning line connected to the main pixel area and a scanning line connected to the sub-pixel area are the same, and a data line connected to the main pixel area and a data line connected to the sub-pixel area are the same.

11. A display module comprising:
a display panel with a first side and a second opposite to each other, the display panel including a plurality of pixel units, each pixel unit including a main pixel area and a sub-pixel area;
a source driver or a gate driver arranged on the first side of the display panel;
from the first side to the second side of the display area, as the distances of the pixel units from the source driver or the gate driver increase, the sizes of the main pixel areas of the pixel units increases and the sizes of the sub-pixel areas decrease;
a weight of the main pixel area occupying an area of the pixel unit is a, and a weight of the sub-pixel area occupying the area of the pixel unit is b, a value range of the weight a is 0<a<1, and the weight b=1−a;
a maximum value of the weight a of the main pixel area is c, and the minimum value of the area weight b of the sub-pixel area is 1−c.

12. A display device comprising a display module, wherein the display module comprises:
a display panel with a display area and a installation area, wherein the installation area is located at a side of the display area; the display panel comprises a plurality of pixel units, each pixel unit comprises a main pixel area and a sub-pixel area;
a pixel driver arranged in the installation area and electrically connected with each pixel unit, set to drive a main pixel and a sub-pixel in the pixel unit;
wherein as distances of the pixel units from the pixel driver increase, sizes of main pixel areas of the pixel units increase and sizes of sub-pixel areas decrease.

13. The display module of claim 12, wherein the pixel driver is a source driver, a first side and a second side are disposed opposite to each other in the display area, and the source driver is disposed in an installation area of the first side;
from the first side to the second side of the display area, as the distances of the pixel units from the pixel driver increase, the sizes of the main pixel areas of the pixel units increases and the sizes of the sub-pixel areas decrease.

14. The display module of claim 12, wherein the pixel driver is a gate driver, the display area has a first side and a second side disposed opposite to each other, and the gate driver is disposed in an installation area of the first side of the display panel;
from the first side to the second side of the display area, as the distances of the pixel units from the pixel driver increase, the sizes of the main pixel areas of the pixel units increases and the sizes of the sub-pixel areas decrease.

15. The display module of claim 12, wherein the pixel driver is a gate driver, the gate driver comprises a first gate driver and a second gate driver;
the number of the installation area is two, and two installation areas are arranged on a first side and a second side oppositely in the display area;
the first gate driver and the second gate driver are respectively arranged in the installation area of the first side and the installation area of the second side of the display panel, in a direction away from both the first gate driver and the second gate driver, as the distances of the pixel units from the first gate driver and the second gate driver increase, the sizes of the main pixel areas of the pixel units increases and the sizes of the sub-pixel areas decrease.

16. The display module of claim 12, wherein a weight of the main pixel area occupying an area of the pixel unit is a, and a weight of the sub-pixel area occupying the area of the pixel unit is b, a value range of the weight a is 0<a<1, and the weight b=1−a.

17. The display module of claim 12, wherein, in the display panel, from top to bottom and/or from left to right, sizes of the main pixel areas gradually increase and sizes of the sub-pixel areas gradually decrease, with a sum of the main pixel area and the sub-pixel area of each pixel remaining unchanged.

18. The display module of claim 16, wherein a maximum value of the area weight a of the main pixel area is c, and the minimum value of the area weight b of the sub-pixel area is 1−c.

19. The display module of claim 16, wherein the weight a of the main pixel area and the weight b of the sub-pixel area vary linearly.

20. The display module of claim 12, wherein the display panel comprises:
an array substrate;
a plurality of scanning lines arranged on the array substrate;
a plurality of data lines arranged on the array substrate;
a plurality of first and second switching elements; wherein each of the data lines is simultaneously connected with one of the first switching elements and one of the second switching elements, and each of the scanning lines is simultaneously connected with one of the first switching elements and one of the second switching elements; wherein,
in each of the pixel units, a scanning line connected to the main pixel area and a scanning line connected to the sub-pixel area are the same, and a data line connected to the main pixel area and a data line connected to the sub-pixel area are the same.
